(19) United States
(12) Patent Application Publication
(10) Pub. No.: US 2026/0065835 A1
(43) Pub. Date: Mar. 5, 2026

(54) DISPLAY DEVICE

(71) Applicant: Sharp Kabushiki Kaisha, Osaka (JP)

(72) Inventor: Junichi MASUDA, Sakai City (JP)

(21) Appl. No.: 19/309,799

(22) Filed: Aug. 26, 2025

(30) Foreign Application Priority Data
Aug. 29, 2024 (JP) 2024-147927

(51) Int. Cl. G09G 3/20

(52) U.S. Cl. CPC G09G 3/2092; G09G 2300/0426; G09G 2300/043; G09G 2310/0267; G09G 2310/0275; G09G 2330/021

(57) ABSTRACT

A display device includes a display surface, a first display pixel, a second display pixel, a first transistor, and a second transistor. The display device can present a first image to a first user at a first position relative to the display surface and a second image different from the first image to a second user at a second position different from the first position. The first display pixel and the second display pixel contribute to forming the first image and the second image, respectively. The first display pixel and the second display pixel are located alternately in a source line arrangement direction in the display device. The first transistor and the second transistor are connected to the first display pixel and the second display pixel, respectively. The first transistor and the second transistor that are adjacent in the source line arrangement direction are connected to an identical source line.

### BACKGROUND

### 1. Field

The following disclosure relates to a display device.

### 2. Description of the Related Art

A display device that can present, by using a single display surface, multiple individual images corresponding to directions in which users (viewers) visually see them is referred to as a multi-view display device. Furthermore, a multi-view display device that can present two individual images corresponding to directions in which users visually see them is referred to as a dual-view display device.

For dual-view display devices, various techniques have been suggested. For example, Japanese Unexamined Patent Application Publication No. 2010-217824 discloses a display control method designed to notify a user of a dual-view display device of more information while giving the user a comfortable feeling.

An aspect of the present disclosure is directed to a dual-view display device that differs in configuration from an existing one.

### SUMMARY

A display device according to an aspect of the present disclosure includes a display surface, a plurality of first display pixels, a plurality of second display pixels, a plurality of source lines, a plurality of first transistors, and a plurality of second transistors. The display device is capable of presenting a first image to a first user located at a first position relative to the display surface and presenting a second image different from the first image to a second user located at a second position different from the first position. The plurality of first display pixels contribute to formation of the first image on the display surface. The plurality of second display pixels contribute to formation of the second image on the display surface. The plurality of source lines are away from each other in a source line arrangement direction. Each first display pixel and each second display pixel are located alternately in the source line arrangement direction. The plurality of first transistors are connected to each of the plurality of first display pixels. The plurality of second transistors are connected to each of the plurality of second display pixels. Each first transistor and each second transistor that are adjacent to each other in the source line arrangement direction are connected to an identical source line.

### BRIEF DESCRIPTION OF THE DRAWINGS

FIG. 1 is a diagram illustrating an operating mode of a display device according to Embodiment 1;

FIG. 2 schematically illustrates a hardware configuration related to an image display in the display device;

FIG. 3 illustrates an example of a circuit configuration in a display device as a comparative example;

FIG. 4 illustrates an example of a circuit configuration in the display device according to Embodiment 1;

FIG. 5 is a flowchart illustrating a processing flow in Embodiment 1; and

FIG. 6 is a flowchart illustrating a processing flow in Embodiment 2.

### DESCRIPTION OF THE EMBODIMENTS

### Embodiment 1

A display device 1 according to Embodiment 1 will be described below. For convenience of explanation, components having the same functions as components described in Embodiment 1 are denoted by the same reference signs in subsequent embodiments, and a description thereof is not repeated. For the sake of simplicity, a description of matters that are the same as those of the known art is also omitted as appropriate.

All of components and numerical values described in the present specification are merely examples as long as there are no contradictions in descriptions. Thus, for example, the positional relationship and connection relationship between components are not limited to an example in each figure as long as there are no contradictions in descriptions. Furthermore, the words of “be connected” in the present specification refer to “be electrically connected” as long as there are no contradictions in descriptions.

### Overview of Display Device 1

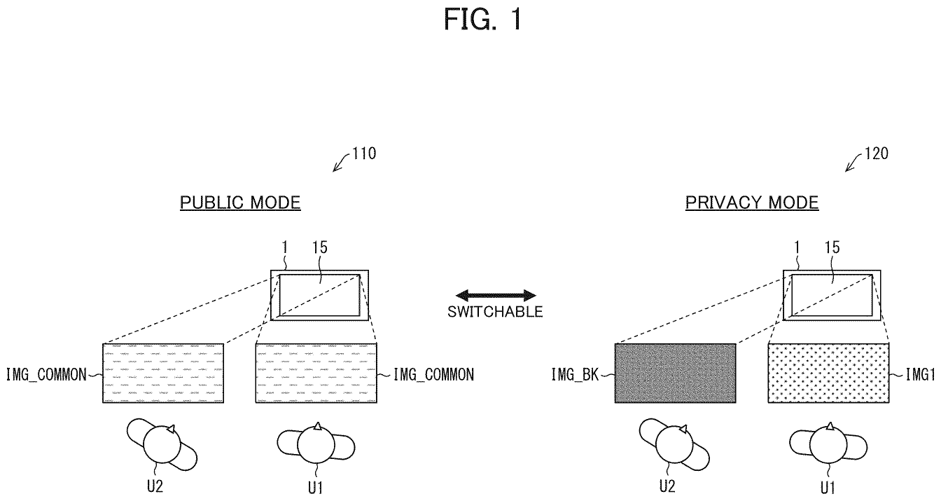

FIG. 1 is a diagram illustrating an operating mode of the display device 1. The display device 1 is configured as a dual-view display device. In addition, the display device 1 is configured to be switchable between two modes: a public mode and a privacy mode.

For conditions for switching between the public mode and the privacy mode of the display device 1, any conditions may be set. In Embodiment 1, the display device 1 includes a control unit (not illustrated) that performs centralized control of individual portions of the display device 1. The control unit may switch between the public mode and the privacy mode in accordance with those conditions.

FIG. 1 illustrates two users as viewers of an image displayed on the display device 1. In the present specification, one of the two users is referred to as a first user U1, and the other is referred to as a second user U2.

In the present specification, the first user U1 is located at a first position relative to a display surface 15 of the display device 1. On the other hand, the second user U2 is located at a second position relative to the display surface 15. In the present specification, the second position is a position different from the first position.

In an example in FIG. 1, the first user U1 is located directly in front of the display surface 15. On the other hand, the second user U2 is located lateral to the display surface 15. Thus, in the example in FIG. 1, the first position is a position directly in front of the display surface 15, and the second position is a position lateral to the display surface 15.

In Embodiment 1, an example is given in which an image is mainly presented to the first user U1. As an example, the display device 1 may be installed in a motor vehicle. In this case, for example, the first user U1 is a person (non-driver) sitting in a passenger seat of the motor vehicle, and the second user U2 is a person (driver) sitting in a driver's seat of the motor vehicle.

The reference sign 110 in FIG. 1 denotes a schematic example of an image display in the public mode. In the public mode, an identical (common) image is presented to both the first user U1 and the second user U2. In the example of the reference sign 110, an image IMG_COMMON is an example of the identical image in the public mode.

On the other hand, the reference sign 120 in FIG. 1 denotes a schematic example of an image display in the privacy mode. The privacy mode is an aspect of a dual display mode. In a typical dual-view display device, in the dual display mode, an image (first image) is presented to the first user U1, and simultaneously a second image different from the first image is presented to the second user U2.

An example of the first image in the dual display mode may be a content image unrelated to driving of the motor vehicle (for example, an entertainment content image). On the other hand, an example of the second image in the dual display mode may be a content image related to driving of the motor vehicle (an information image presented by software of a car navigation system).

However, to allow the second user U2 to concentrate on driving the motor vehicle, it may be desirable that the second user U2's attention is not distracted by the second image. Thus, in the privacy mode, a black display image is presented as the second image. In the example of the reference sign 120, an image IMG1 is an example of the first image, and an image IMG_BK is an example of the second image as a black display image. The black display image is an image in which all gray-level values are zero.

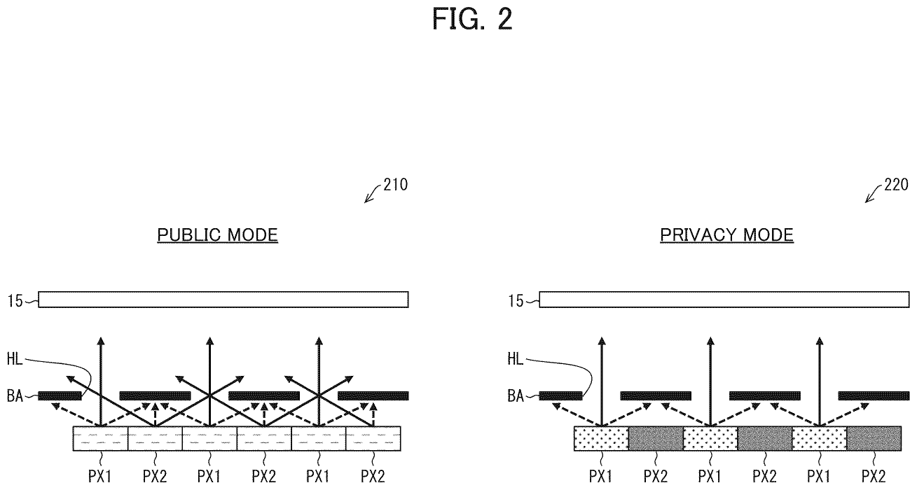

FIG. 2 schematically illustrates a hardware configuration related to an image display in the display device 1. FIG. 2 is a counterpart to FIG. 1. As illustrated in FIG. 2, the display device 1 includes, as a plurality of display pixels, a plurality of first display pixels PX1, and a plurality of second display pixels PX2.

Each first display pixel PX1 is a display pixel that contributes to formation of the first image on the display surface 15 in the dual display mode. On the other hand, each second display pixel PX2 is a display pixel that contributes to formation of the second image on the display surface 15 in the dual display mode. In Embodiment 1, in a source line arrangement direction to be described, the first display pixel PX1 and the second display pixel PX2 are located alternately.

As illustrated in FIG. 2, the display device 1 includes a barrier BA. The barrier BA is also referred to as a parallax barrier. The barrier BA only has to include any light-absorbing material. Thus, the barrier BA may also be referred to as a light-shielding portion. In an example in FIG. 2, the barrier BA covers only part of the first display pixel PX1 when viewed from the display surface 15.

On the other hand, the barrier BA covers the entire second display pixel PX2 when viewed from the display surface 15. The barrier BA is located closer to the viewers than the first display pixel PX1 and the second display pixel PX2. Thus, as illustrated in FIG. 2, an opening HL is formed in the barrier BA. The opening HL is located so that part of the first display pixel PX1 is exposed when viewed from the display surface 15.

The reference sign 210 in FIG. 2 denotes a schematic example of operation of the display device 1 in the public mode. As described above, in the public mode, an identical image (for example, image IMG_COMMON) is presented to the first user U1 and the second user U2. Thus, in the public mode, the first display pixel PX1 and the second display pixel PX2 are respectively driven so that (i) the image IMG_COMMON to be presented to the first user U1 is formed by the first display pixel PX1 and so that (ii) the image IMG_COMMON to be presented to the second user U2 is formed by the second display pixel PX2.

In the example in FIG. 2, most of the first display pixel PX1 is not covered by the barrier BA. Hence, most of light emitted from the first display pixel PX1 passes through the opening HL and reaches the display surface 15. The image IMG_COMMON to be presented to the first user U1 is formed on the display surface 15 by the light. In Embodiment 1, the first display pixel PX1 is configured so that light emitted from the first display pixel PX1 is mainly directed toward the first position.

On the other hand, the second display pixel PX2 is covered by the barrier BA. Hence, most of light emitted from the second display pixel PX2 is blocked by the barrier BA. However, some of light emitted from the second display pixel PX2 is directed toward sides of the display surface 15. Hence, of light emitted from the second display pixel PX2, some directed toward the sides of the display surface 15 passes through the opening HL and reaches the display surface 15. The image IMG_COMMON to be presented to the second user U2 is formed on the display surface 15 by the light.

The reference sign 220 in FIG. 2 denotes a schematic example of operation of the display device 1 in the privacy mode. As described above, the second image in the privacy mode is a black display image. Thus, in the privacy mode, the second display pixel PX2 is not driven. Hence, in the privacy mode, no light is emitted from the second display pixel PX2.

On the other hand, in the privacy mode, the first display pixel PX1 is driven so that the first image to be presented to the first user U1 is formed by the first display pixel PX1. Hence, in the privacy mode, light is emitted only from the first display pixel PX1.

Circuit Configuration in Comparative Example Before describing a circuit configuration in the display device 1, a comparative example will be described. In the present specification, a display device as a comparative example is referred to as a display device 1R. The display device 1R is an example of an existing dual-view display device.

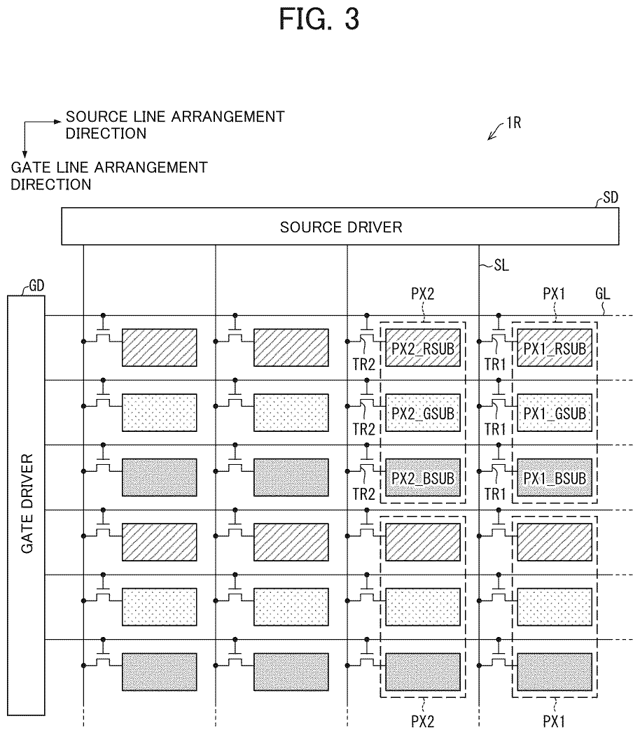

FIG. 3 illustrates an example of a circuit configuration in the display device 1R. The display device 1R includes a plurality of source lines SL that are away from each other in a source line arrangement direction (in the example in FIG. 3, a lateral direction in the plane of the drawing). The display device 1R includes a source driver SD that drives each source line SL. The source driver SD supplies a source signal (for example, an image signal) to the source line SL.

The display device 1R includes a plurality of gate lines GL that are away from each other in a gate line arrangement direction. The gate line arrangement direction only has to be a direction intersecting with the source line arrangement direction. The gate line arrangement direction in the example in FIG. 3 is a longitudinal direction in the plane of the drawing. Hence, in the example in FIG. 3, the gate line arrangement direction is orthogonal to the source line arrangement direction. The display device 1R includes a gate driver GD that drives each gate line GL. The gate driver GD supplies a gate signal to the gate line GL.

In the display device 1R in FIG. 3 as well, in the source line arrangement direction, the first display pixel PX1 and the second display pixel PX2 are located alternately. In Embodiment 1, an example is given in which one display pixel is constituted by one red sub-display pixel, one green sub-display pixel, and one blue sub-display pixel.

In the example in FIG. 3, the reference sign PX1_RSUB denotes a red sub-display pixel constituting the first display pixel PX1. The red sub-display pixel constituting the first display pixel PX1 may be referred to as a first red sub-display pixel. The reference sign PX1_GSUB denotes a green sub-display pixel constituting the first display pixel PX1. The green sub-display pixel constituting the first display pixel PX1 may be referred to as a first green sub-display pixel. The reference sign PX1_BSUB denotes a blue sub-display pixel constituting the first display pixel PX1. The blue sub-display pixel constituting the first display pixel PX1 may be referred to as a first blue sub-display pixel.

The reference sign PX2_RSUB denotes a red sub-display pixel constituting the second display pixel PX2. The red sub-display pixel constituting the second display pixel PX2 may be referred to as a second red sub-display pixel. The reference sign PX2_GSUB denotes a green sub-display pixel constituting the second display pixel PX2. The green sub-display pixel constituting the second display pixel PX2 may be referred to as a second green sub-display pixel. The reference sign PX2_BSUB denotes a blue sub-display pixel constituting the second display pixel PX2. The blue sub-display pixel constituting the second display pixel PX2 may be referred to as a second blue sub-display pixel.

The display device 1R includes a plurality of transistors to drive each display pixel. In the example in FIG. 3, a thin film transistor (TFT) is illustrated as a transistor. In the example in FIG. 3, each of the plurality of transistors is connected to the source line SL and the gate line GL.

More specifically, a source terminal of each of the plurality of transistors is connected to the source line SL, and a gate terminal of each of the plurality of transistors is connected to the gate line GL. In addition, a drain terminal of each of the plurality of transistors is connected to the display pixel.

In the example in FIG. 3, one transistor is connected to one sub-display pixel. Specifically, the drain terminal of the one transistor is connected to the one sub-display pixel. Hence, three transistors are connected to one display pixel. In this way, the display pixels are connected to the source lines SL and the gate lines GL via the transistors.

In the present specification, the transistors connected to the first display pixel PX1 are referred to as first transistors TR1. In the example in FIG. 3, three first transistors TR1 are connected to one first display pixel PX1. A first one of the three first transistors TR1 is connected to the first red sub-display pixel PX1_RSUB. A second one of the three first transistors TR1 is connected to the first green sub-display pixel PX1_GSUB. A third one of the three first transistors TR1 is connected to the first blue sub-display pixel PX1_BSUB.

In the present specification, the transistors connected to the second display pixel PX2 are referred to as second transistors TR2. In the example in FIG. 3, three second transistors TR2 are connected to one second display pixel PX2. A first one of the three second transistors TR2 is connected to the second red sub-display pixel PX2_RSUB. A second one of the three second transistors TR2 is connected to the second green sub-display pixel PX2_GSUB. A third one of the three second transistors TR2 is connected to the second blue sub-display pixel PX2_BSUB.

In the example in FIG. 3, the first transistor TR1 and the second transistor TR2 that are adjacent to each other in the source line arrangement direction are connected to individual source lines SL. Hence, the first display pixel PX1 and the second display pixel PX2 that are adjacent to each other in the source line arrangement direction are connected to the individual source lines SL.

### Circuit Configuration in Display Device 1

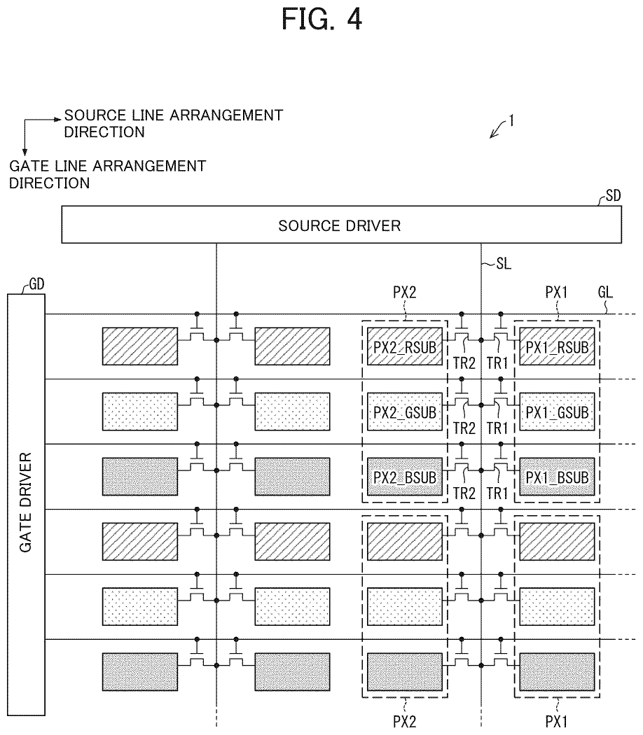

FIG. 4 illustrates an example of a circuit configuration in the display device 1. FIG. 4 is a counterpart to FIG. 3. In the example in FIG. 4, the first transistor TR1 and the second transistor TR2 that are adjacent to each other in the source line arrangement direction are connected to an identical (common) source line SL. Hence, the first display pixel PX1 and the second display pixel PX2 that are adjacent to each other in the source line arrangement direction are connected to the identical source line SL. In other words, in the display device 1, unlike the display device 1R, one source line SL is shared by the first display pixel PX1 and the second display pixel PX2 that are adjacent to each other in the source line arrangement direction.

Hence, in the display device 1, unlike the display device 1R, the one source line SL is shared by the first transistor TR1 and the second transistor TR2 that are adjacent to each other in the source line arrangement direction. The circuit configuration in FIG. 4 enables the total number of source lines SL in the display device to be reduced compared with the circuit configuration in FIG. 3.

In both the examples in FIGS. 3 and 4, the first transistor TR1 and the second transistor TR2 that are adjacent to each other in the source line arrangement direction are connected to an identical gate line GL. In view of driving the first display pixel PX1 and the second display pixel PX2 individually in the dual display mode (for example, privacy mode) of the display device 1, it is desirable that characteristics of the first transistor TR1 differ from characteristics of the second transistor TR2.

In the present specification, a gate voltage threshold of the first transistor TR1 is referred to as a first gate voltage threshold. On the other hand, a gate voltage threshold of the second transistor TR2 is referred to as a second gate voltage threshold. In Embodiment 1, it is desirable that the first transistor TR1 and the second transistor TR2 are manufactured so that the first gate voltage threshold and the second gate voltage threshold are different.

As an example, a gate voltage threshold of a transistor can depend on doping conditions of the transistor. Hence, for example, when the first transistor TR1 and the second transistor TR2 are manufactured under their respective different doping conditions, the first gate voltage threshold and the second gate voltage threshold can be made different.

Furthermore, a gate voltage threshold of a transistor can also depend on the size of the transistor. Hence, for example, when the first transistor TR1 and the second transistor TR2 of different sizes are manufactured, the first gate voltage threshold and the second gate voltage threshold can be made different.

When the first gate voltage threshold and the second gate voltage threshold are made different, if a certain gate voltage is applied to both the first transistor TR1 and the second transistor TR2 via the identical gate line GL, only the first transistor TR1 or the second transistor TR2 can be turned on. In other words, when the first gate voltage threshold and the second gate voltage threshold are made different, only the first display pixel PX1 or the second display pixel PX2 connected to an identical source line SL can be driven.

### Example of Processing Flow in Display Device 1

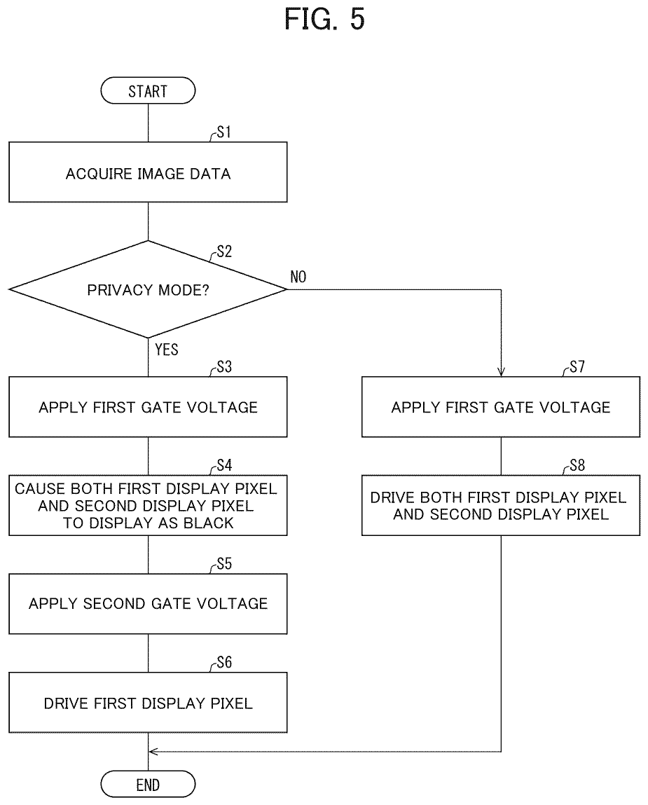

FIG. 5 is a flowchart illustrating a processing flow in the display device 1. As an example, a process illustrated in FIG. 5 is performed by the above-described control unit controlling each portion of the display device 1.

In step S1, the control unit acquires image data to be displayed. Subsequently, in step S2, the control unit determines whether or not a current operating mode of the display device 1 is the privacy mode.

When the determination made in step S2 is YES, that is, when the current operating mode is the privacy mode, the process proceeds to step S3. In step S3, the display device 1 applies a predetermined gate voltage (first gate voltage) to each of the plurality of transistors TR. Specifically, in step S3, the gate driver GD applies the first gate voltage as a gate signal to each of the plurality of gate lines GL in accordance with a command from the control unit.

As described above, the first transistor TR1 and the second transistor TR2 that are adjacent to each other in the source line arrangement direction are connected to the identical gate line GL. Hence, in step S3, the first gate voltage is applied to the first transistor TR1 and the second transistor TR2 via the identical gate line GL.

Subsequently, in step S4, the display device 1 causes both the first display pixel PX1 and the second display pixel PX2 to display as black. In other words, the display device 1 stops both the first display pixel PX1 and the second display pixel PX2. Hence, in step S4, the brightnesses of both the first display pixel PX1 and the second display pixel PX2 are zero. Specifically, in step S4, the source driver SD applies a source signal corresponding to a black display image to each of the plurality of source lines SL in accordance with a command from the control unit.

Subsequently, in step S5, the display device 1 applies a second gate voltage different from the first gate voltage to each of the plurality of transistors TR. Specifically, in step S5, the gate driver GD applies the second gate voltage as a gate signal to each of the plurality of gate lines GL in accordance with a command from the control unit.

As described above, the first transistor TR1 and the second transistor TR2 that are adjacent to each other in the source line arrangement direction are connected to the identical gate line GL. Hence, in step S5, the second gate voltage is applied to the first transistor TR1 and the second transistor TR2 via the identical gate line GL.

In Embodiment 1, an example is given in which the second gate voltage is lower than the first gate voltage. As an example, the first gate voltage is 5 V, and the second gate voltage is 3 V. In this case, for example, it is desirable that the first gate voltage threshold is set lower than the second gate voltage. It is also desirable that the second gate voltage threshold is set higher than the second gate voltage and lower than the first gate voltage.

When the first gate voltage threshold and the second gate voltage threshold are set as described above, in step S6 (processing in the privacy mode) to be described below, only the first display pixel PX1 can be driven by using the circuit configuration in FIG. 4. On the other hand, in step S8 (processing in the public mode) to be described, both the first display pixel PX1 and the second display pixel PX2 can be driven. From the above, it is desirable that the first gate voltage threshold is set lower than the second gate voltage threshold.

Subsequently, in step S6, the display device 1 drives the first display pixel PX1. That is, the display device 1 causes, of the first display pixel PX1 and the second display pixel PX2, only the first display pixel PX1 to display an image. Hence, in step S6, the brightness of only the first display pixel PX1 is non-zero.

Specifically, in step S6, the source driver SD applies a source signal corresponding to the image data acquired in step S1 to each of the plurality of source lines SL in accordance with a command from the control unit. When the first gate voltage threshold and the second gate voltage threshold are set as described above, as a result in step S5, only the second transistor TR2 is turned off. Hence, it is possible to keep the second display pixel PX2 from being driven in step S6.

As a result of the processing in step S6, the first display pixel PX1 forms an image corresponding to the image data acquired in step S1 on the display surface 15 as a first image. On the other hand, the second display pixel PX2 forms a second image on the display surface 15 as a black display image. Hence, the display in the privacy mode illustrated in FIG. 1 is provided.

When the determination made in step S2 described above is NO, that is, when the current operating mode is not the privacy mode (that is, when the current operating mode is the public mode), the process proceeds to step S7.

In step S7, the display device 1 applies the first gate voltage to each of the plurality of transistors TR. Step S7 is the same processing as step S3 described above.

Subsequently, in step S8, the display device 1 drives the first display pixel PX1 and the second display pixel PX2. That is, the display device 1 causes both the first display pixel PX1 and the second display pixel PX2 to display an image. Hence, in step S8, the brightnesses of both the first display pixel PX1 and the second display pixel PX2 are non-zero.

Specifically, in step S8, the source driver SD applies a source signal corresponding to the image data acquired in step S1 to each of the plurality of source lines SL in accordance with a command from the control unit. When the first gate voltage threshold and the second gate voltage threshold are set as described above, as a result in step S7, both the first transistor TR1 and the second transistor TR2 are turned on. Hence, it is possible to drive both the first display pixel PX1 and the second display pixel PX2 in step S8.

As a result of the processing in step S8, each of the first display pixel PX1 and the second display pixel PX2 forms an image corresponding to the image data acquired in step S1 on the display surface 15. Hence, the display in the public mode illustrated in FIG. 1 is provided.

### Effects

As described above, in Embodiment 1, the display device 1 is provided as a dual-view display device that differs in configuration from an existing one.

Specifically, in the display device 1, unlike an existing display device (for example, display device 1R), one source line SL is shared by the first transistor TR1 and the second transistor TR2 that are adjacent to each other in the source line arrangement direction.

Embodiment 1 enables the total number of source lines SL in the display device to be reduced compared with the existing display device. Hence, Embodiment 1 contributes to the facilitation of the design and cost reduction of the dual-view display device. In addition, when the total number of source lines SL is reduced compared with the existing dual-view display device, power consumption can also be reduced compared with the existing dual-view display device.

Furthermore, in Embodiment 1, individual source signals do not have to be supplied to the first transistor TR1 and the second transistor TR2 to cause the first display pixel PX1 to display the first image and cause the second display pixel PX2 to display the black display image in the privacy mode. Hence, the display device 1 also contributes to the facilitation of signal processing in the dual-view display device. For this reason, in the display device 1, for example, a low-cost integrated circuit (IC) can be used as the source driver SD.

### Embodiment 2

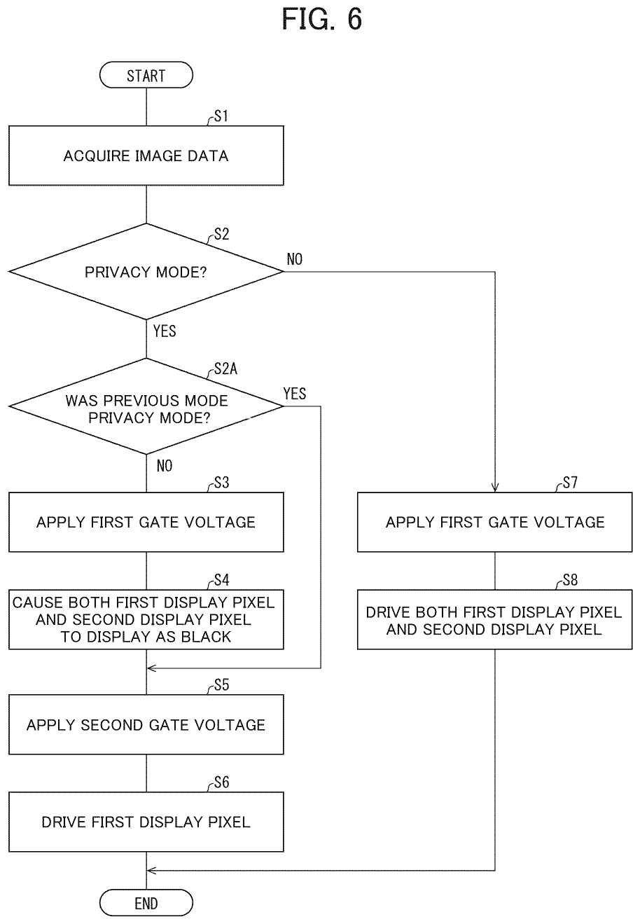

The processing flow in the display device 1 is not limited to the examples in Embodiment 1. In Embodiment 2, a flowchart different from that in FIG. 5 will be described. FIG. 6 is a flowchart illustrating a processing flow in the display device 1 in Embodiment 2.

In an example in FIG. 6, step S2A is provided between steps S2 and S3 described above. In step S2A, the control unit determines whether or not a previous operating mode was the privacy mode. In other words, the control unit determines whether or not a previous image display was provided in the privacy mode.

When the determination made in step S2A is YES, that is, when the previous operating mode was the privacy mode, the process proceeds to step S5. Hence, when the determination made in step S2A is YES, steps S3 and S4 described above are omitted.

On the other hand, when the determination made in step S2A is NO, that is, when the previous operating mode was not the privacy mode (that is, when the previous operating mode was the public mode), the process proceeds to step S3.

In the processing flow in FIG. 6, when the operation in the privacy mode continues, the number of times steps S3 and S4 are performed is reduced compared with the example in FIG. 5. Hence, in the processing flow in FIG. 6, power consumption can be reduced compared with the example in FIG. 5.

Furthermore, in the processing flow in FIG. 6, when the operation in the privacy mode continues, the number of times an image is written into the display device 1 is reduced compared with the example in FIG. 5. As a result, in the processing flow in FIG. 6, when the operation in the privacy mode continues, image display quality can also be improved compared with the example in FIG. 5.

### Implementation Example by Software

A function of the display device 1 can be implemented by a program for causing a computer to function as this device. The program is a program for causing the computer to function as control blocks of this device.

In this case, the above-described device includes, as hardware for executing the above-described program, a computer including at least one control device (for example, processor) and at least one storage device (for example, memory). When the above-described program is executed by the control device and the storage device, functions described in each embodiment described above are implemented.

The above-described program may be recorded in one or more non-temporary computer-readable recording media. The above-described device may include such a recording medium or include no such a recording medium. In the latter case, the above-described program may be supplied to the above-described device via any wired or wireless transmission medium.

Some or all of functions of each control block described above can also be implemented by a logic circuit. For example, an integrated circuit in which a logic circuit functioning as each control block described above is formed also falls within the scope of an aspect of the present disclosure. In addition, the functions of each control block described above can also be implemented, for example, by a quantum computer.

The processes described in the above-described embodiments may be performed by an artificial intelligence (AI). In this case, the AI may operate in the above-described control device or in another device (such as an edge computer, or cloud server).

### SUMMARY

A display device according to Aspect 1 of the present disclosure includes a display surface, a plurality of first display pixels, a plurality of second display pixels, a plurality of source lines, a plurality of first transistors, and a plurality of second transistors. The display device is capable of presenting a first image to a first user located at a first position relative to the display surface and presenting a second image different from the first image to a second user located at a second position different from the first position. The plurality of first display pixels contribute to formation of the first image on the display surface. The plurality of second display pixels contribute to formation of the second image on the display surface. The plurality of source lines are away from each other in a source line arrangement direction. Each first display pixel and each second display pixel are located alternately in the source line arrangement direction. The plurality of first transistors are connected to each of the plurality of first display pixels. The plurality of second transistors are connected to each of the plurality of second display pixels. Each first transistor and each second transistor that are adjacent to each other in the source line arrangement direction are connected to an identical source line.

In Aspect 1 described above, in the display device according to Aspect 2 of the present disclosure, a first gate voltage threshold, which is a gate threshold voltage of the first transistor, may be different from a second gate voltage threshold, which is a gate threshold voltage of the second transistor.

In Aspect 2 described above, in the display device according to Aspect 3 of the present disclosure, the first gate voltage threshold may be lower than the second gate voltage threshold.

In any one of Aspects 1 to 3 described above, the display device according to Aspect 4 of the present disclosure may further include a plurality of gate lines that are away from each other in a gate line arrangement direction intersecting with the source line arrangement direction. The first transistor and the second transistor that are adjacent to each other in the source line arrangement direction may be connected to an identical gate line.

In Aspect 4 described above, the display device according to Aspect 5 of the present disclosure may apply a first gate voltage to the first transistor and the second transistor that are adjacent to each other in the source line arrangement direction, and may apply a second gate voltage lower than the first gate voltage to the first transistor and the second transistor.

In Aspect 5 described above, the display device according to Aspect 6 of the present disclosure may stop the first display pixel and the second display pixel after applying the first gate voltage to the first transistor and the second transistor that are adjacent to each other in the source line arrangement direction, and may drive the first display pixel after applying the second gate voltage to the first transistor and the second transistor.

In any one of Aspects 1 to 6 described above, in the display device according to Aspect 7 of the present disclosure, the first position may be a position directly in front of the display surface, and the second position may be a position lateral to the display surface.

In any one of Aspects 1 to 7 described above, in the display device according to Aspect 8 of the present disclosure, the second image may be a black display image.

### Notes

An aspect of the present disclosure is not to be limited to the above-described embodiments, and various modifications can be made within the scope described in claims. An embodiment obtained by appropriately combining technical means disclosed in respective different embodiments is also included in the technical scope of an aspect of the present disclosure. Furthermore, new technical features can also be formed by combining technical means disclosed in the respective embodiments.

The present disclosure contains subject matter related to that disclosed in Japanese Priority Patent Application JP 2024-147927 filed in the Japan Patent Office on Aug. 29, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display surface;
a plurality of first display pixels;
a plurality of second display pixels;
a plurality of source lines;
a plurality of first transistors; and
a plurality of second transistors,
wherein the display device is configured to be capable of presenting a first image to a first user located at a first position relative to the display surface and presenting a second image different from the first image to a second user located at a second position different from the first position,
wherein the plurality of first display pixels contribute to formation of the first image on the display surface,
wherein the plurality of second display pixels contribute to formation of the second image on the display surface,
wherein the plurality of source lines are away from each other in a source line arrangement direction,
wherein each first display pixel and each second display pixel are located alternately in the source line arrangement direction,
wherein the plurality of first transistors are connected to each of the plurality of first display pixels,
wherein the plurality of second transistors are connected to each of the plurality of second display pixels, and
wherein each first transistor and each second transistor that are adjacent to each other in the source line arrangement direction are connected to an identical source line.

2. The display device according to claim 1,
wherein a first gate voltage threshold, which is a gate threshold voltage of the first transistor, is different from a second gate voltage threshold, which is a gate threshold voltage of the second transistor.

3. The display device according to claim 2,
wherein the first gate voltage threshold is lower than the second gate voltage threshold.

4. The display device according to claim 1, further comprising
a plurality of gate lines that are away from each other in a gate line arrangement direction intersecting with the source line arrangement direction,
wherein the first transistor and the second transistor that are adjacent to each other in the source line arrangement direction are connected to an identical gate line.

5. The display device according to claim 4,
wherein the display device is configured to
apply a first gate voltage to the first transistor and the second transistor that are adjacent to each other in the source line arrangement direction via the identical gate line, and
apply a second gate voltage lower than the first gate voltage to the first transistor and the second transistor via the identical gate line.

6. The display device according to claim 5,
wherein the display device is configured to
stop the first display pixel and the second display pixel after applying the first gate voltage to the first transistor and the second transistor that are adjacent to each other in the source line arrangement direction, and
drive the first display pixel after applying the second gate voltage to the first transistor and the second transistor.

7. The display device according to claim 1,
wherein the first position is a position directly in front of the display surface, and
wherein the second position is a position lateral to the display surface.

8. The display device according to claim 1, wherein the second image is a black display image.
